(19) United States
(12) Patent Application Publication
(10) Pub. No.: US 2011/0272895 A1
(43) Pub. Date: Nov. 10, 2011

(54) Profile Seal with Corner Connectors

(75) Inventors: Peter Kritzer, Forst (DE); Frank Schoenberg, Lampertheim (DE); Thomas Kramer, Rimbach (DE); Ricki Paul, Heidelberg (DE); Frank Lauer, Wiesloch (DE); Georg Puett, Grasellenbach (DE); Olaf Nahrwold, Ludwigshafen (DE); Thomas Klenk, Dossenheim (DE)

(73) Assignee: CARL FREUDENBERG KG, Weinheim (DE)

(21) Appl. No.: 12/953,937

(22) Filed: Nov. 24, 2010

(30) Foreign Application Priority Data
May 6, 2010 (EP) 10-004795.0

(51) Int. Cl. F16J 15/02

(52) U.S. Cl. 277/630

(57) ABSTRACT

A seal (2) for a housing, in particular, for a battery housing or for another electrochemical energy storage device, comprising a base body (5), the base body (5) having profile seals (6) with profiled sealing surfaces (7), and the profile seals (6) having first ends (6a) and second ends (6b) are interconnected by a corner connector (8) at one end (6a, 6b) of each seal.

### CROSS-REFERENCE TO RELATED APPLICATIONS

This application claims the benefit and priority of European Patent Application No. 10-004795.0, filed May 6, 2010. The entire disclosure of the above application is incorporated herein by reference.

### FIELD

The present disclosure relates to a seal for a housing, in particular for a battery housing or for another electrochemical energy storage device, comprising a base body, the base body having profile seals with profiled sealing surfaces, wherein the profile seals have first ends and second ends.

### BACKGROUND

This section provides background information related to the present disclosure which is not necessarily prior art.

Extruded profile seals are used to seal large-surface components. Examples are housings which consist of a tank with a suitable cover.

Profile seals facilitate an optimal mechanical design with respect to compressive or setting behavior. In this way, the distances between fastening screws can be reduced, for example, without having to expect mechanical distortion between two components. This will permit the housing to be opened multiple times without distortion (“corrugated ion phenomenon”).

Mounting profile seals around corners is frequently extremely difficult, because the sealing characteristics deteriorate as a result of the material displacement associated with the curvature.

This becomes increasingly problematic, the more complicated the profile of the profile seal is.

Complicated profiles are frequently not suitable for narrow bends. Moreover, high tolerances result if profile seals are inaccurately cut-off manually.

Especially in places where custom-designed profiles have been used, sealing problems occur particularly on corners. Using even simple profile seals, such as a round cord, it is not possible to produce small curve radii of any size.

In addition, elastomers can shrink during storage. It is therefore advantageous either to cut off extruded profile seals just before they are used or to use elastomers which have relatively low shrinkage.

For series production, housing seals as components are produced on tools made especially for that purpose. As a rule, said seals can only be produced economically in larger numbers of more than about 1000 pieces, especially because this requires great investment for appropriate tools and large-scale presses.

For this reason, for requirements of this type involving small numbers, primarily flat seals made from mats or sheet material are manufactured. The disadvantage of this process is that a large amount of material is wasted. Another disadvantage is that it is not possible to adapt a profile seal to the application. When mat or plate material is used, problems can occur during the manufacture of profile seals.

Sealing beads that are applied on covers or tanks of housings and are subsequently cured do not facilitate an optimized profile design. Moreover, only a relatively small spectrum of elastomers is available for sealing beads. Another disadvantage is that sealing beads that are mounted in this way can detach during the opening of the housing and can therefore become unusable. In order to make a replacement seal, it is then necessary to supply the cover and/or the tank to a sealing bead application device.

In view of this background, it is desirable to be able to offer optimized housing seals even in smaller quantities.

Large-sized battery systems and/or other electrochemical storage devices such as super capacitors are being used in increasing numbers of applications.

For example, in electric vehicles or hybrid vehicles, in industrial transport systems, such as forklifts or robots, in shop trucks, and in sport utility vehicles. Additional applications can be found in rail vehicles and in aircraft.

In all these applications, the batteries are normally made up of a multiplicity of individual cells which are fitted into a battery housing. Typical voltages used in such energy storage devices can be up to 1000 V. Amperages of more than 100 A are possible. Typical dimensions of the battery housings are 500 mm×800 mm.

The purpose of the battery housing is to protect the internal components against the environment. The ingress of water or other conductive fluids into the battery housing is particularly harmful, since said fluids can cause short-circuiting in case of contact with current-carrying components, and can react violently with the active components of the cells, especially with lithium, in which case hydrogen gas is liberated, for instance. Furthermore, corrosion of the control electronics and/or the battery management system can occur.

Since battery systems are very expensive, it must be possible to open the battery housing frequently. Otherwise, a loose contact in the control electronics could be repaired only after cutting open a battery housing by welding, for example. The process of cutting open by welding has a high risk, however, because the temperature sensitive battery components could incur sustained damage.

The housings of large-sized energy storage devices usually consist of a tank into which the components are placed, and a cover. The cover and the tank are made of either metal or high-strength plastic. They are firmly bonded and tightly joined to each other. Elastomer seals are frequently used as the seals.

As a rule, the battery housing and/or the battery housing-to-seal connection must provide protection against dust, protection against occasional contact with water from the outside, as well as protection against water from external sources, such as cleaning equipment, for example, high-pressure washers.

The battery housing must comply with the requirements of the safety class IP 67. During this test, water is applied from the outside at a pressure of 0.1 bar (1 m water head) over a period of 30 min. Following this test, there must be no water inside of the battery housing. For special applications, such as for batteries for off-road vehicles or electric craft, still further requirements may be necessary, such as compliance with safety class IP 68.

In addition, it can be required to protect the inside of a battery housing against electromagnetic stray radiation and/or to ensure that the battery does not emit electromagnetic stray radiation, which would have consequences for the seal design. Moreover, the seal should be able to compensate for tolerances of the surface quality as well as for distortion of the components of the battery housing.

The aforementioned requirements can also be necessary in further applications, such as for control panels, loading stations for electro-mobile devices, and windows.

Vulcanized flat seals are presently known from the prior art. These can comprise a profile for optimal tolerance compensation, permit rapid assembly and a step-like structure.

The disadvantage of these seals is that they require large tools. This involves high costs. Manufacturing therefore becomes worthwhile only with quantities of more than 1000 pieces. The seals are defined for one design and for one user and are normally limited to series production.

Is also known to apply a seal to the cover or the tank by means of bead application. In this context it is advantageous that such seals can be applied flexibly to battery housings of different sizes. The disadvantage is that almost no profiling can be applied, that the surface must be pretreated, if necessary, such as by degreasing or activation, that large-sized components, such as covers, must be handled, and that a bead application apparatus must be available.

During the opening of the battery housing, the seal is normally destroyed, because it randomly adheres to the cover and/or the tank.

In addition, punched seals from solid material, for example sheets, in particular made of closed-cell materials such as “microcellular rubber,” are known. These can be produced easily almost without tooling costs. A disadvantage, on the other hand, is that no topographic profile can be produced on these in order to obtain tolerance compensation. In addition, these seals generate a relatively large amount of material waste, since in the punching process the material that is left in the middle of a sheet can no longer be used. Furthermore, the thickness tolerances of the sheet material can impair the sealing characteristics of the sheet material, at which point a residual compression set can occur. With large pressure surfaces, tolerance compensation is low, and with narrow structures, these seals are difficult to handle. In addition, especially foam materials have a relatively unfavorable compression set.

Profile seals that are glued together or vulcanized on joints are also known. These seals permit a profile to be formed. A disadvantage is, however, that with material shrinkage it can occur that the intended geometries are no longer true to size. Moreover, the seals cannot be handled easily and can no longer be varied following vulcanization. The replacement of individual sections of seals, which may have become unusable through aging chemical or thermal attack, for example, is difficult or is only possible by replacing the entire seal. The result is therefore the following situation at present:

For large quantities, a seal can be sized perfectly. However, this requires expensive tools, so that this type of seal becomes economical only with large quantities.

For prototypes and pre-series items, there is no optimum solution up to this point.

Seals produced from solid material cannot be structured topographically, and therefore have only limited capability of tolerance compensation. Moreover, with respect to flexibility and with respect to their sizing, they usually do not fulfill the requirements of battery manufacturers.

### SUMMARY

This section provides a general summary of the disclosure, and is not a comprehensive disclosure of its full scope or all of its features.

The problem addressed by the invention is therefore to specify a modular seal which combines the advantages of a profile seal with that of a flexible design.

According to the present disclosure, a seal of the type mentioned at the outset is characterized in that at least two profile seals are connected to each other by a corner connector at one end of each seal.

According to the invention it has been recognized that a profile seal can be created as a full perimeter sealing gasket design with the help of corner connectors. Therefore, optimized profile seals can be used over a large area without having to bend them around corners. As a result of this design, housing components can be joined to one another for sustained periods.

At the same time, the design is tolerant with respect to length variations of the profile seal. The cover-housing system is still tight even if a profile seal is cut a little too short within tolerances.

Surprisingly, such a modular system is also tight against any liquid contact from the outside. Because the contact surface on one side, normally on the tank of a battery housing, is larger than on the other side, especially on the cover, it can be opened without any problems without the profile seal sticking to the cover. This will ensure that the housing can be opened again multiple times without damaging the seal.

A particular advantage of the flexible sealing system also lies in applications in which, depending upon the component, particularly large variations in manufacturing dimensions are to be expected, due to manufacturing processes, sizes, etc. In this instance, seals that are produced with one tool will normally securely seal only the average dimensional range, but sealing problems can be expected in the extreme ranges. On the other hand, this novel, modular approach in this instance facilitates the use of a single thicker or thinner special corner joint or a single thicker or thinner profile seal to securely seal isolated defects or extreme deviations from tolerances. Moreover, a corner connector, i.e. the profile seal connection, can thus be specifically optimized in terms of different stiffnesses of a cover or flange connection. In areas, for example, in which high surface pressure is available, profile seals made of harder materials or designs, and in areas where the distances between screws is large, especially soft variants can be used. The problem stated at the beginning is therefore solved.

At least one profile seal could be coaxially cambered with the application of pressure on its sealing surface. This facilitates a reliable seal. The profile seal works especially well when it yields toward the outside upon action of force from above. A cross-section of the seal that forms a “cavity,” such as is used for normal profile seals, results in a surprising leakage flow that occurs around the profile seal in the corner connector. Depending upon the surface of the cavity, this leakage occurs only after an extended service life.

At least one profile seal could comprise an internal cavity, surrounded by profile seal material. This facilitates the bulging of the profile seal upon the application of pressure.

The corner connectors could be softer than the profile seals. Corner connectors are subject to comparatively low requirements in terms of their elasticity, since the profile seal takes over the sealing function. For this reason, a corner connector should be softer than the profile seal. The softer material also has the advantage that it can follow the bulge of the pressurized profile seal in that it is positively displaced, which ensures the sealing effect.

The corner connectors could be produced from a soft elastomer solid material. Such materials have the advantage that they have no pores, which during processing, such as punching, leave behind an open and/or rough surface.

The corner connectors could be produced from an elastic, closed-cell material, i.e. a foam material. This has the advantage of a lower weight and an even better resilience during the bulging of the profile seal. With foam material it was found that materials with average pore sizes of the closed pores of less than 0.1 mm could be used without any seal problems.

With materials having average pore sizes of the closed pores of more than 0.3 mm, seal problems can occur depending on the circumstances, which can be attributed to the high roughness of cut pores.

The corner connectors could have a multilayer structure. In this manner, the forces along a deformation path can be adjusted. The corner connectors could consist of materials having a different hardness along their height.

In this way, an optimized gradually increasing deformation path/force ratio can be achieved.

The corner connectors could have cutouts for holding the ends of the profile seals. For this purpose, cutouts are formed in the corner connectors into which a profile seal is inserted. A cutout in the corner connectors must have special dimensions in order to interact with the profile seal. Through the special form of the cutout, comparatively large differences can be tolerated when the profile seals are cut to length.

The cross-section of the cutouts can be trapezoidal. Therefore, one end of a profile seal can be wedged.

The trapezoidal shape could be formed such that the cutout widens or tapers in the direction of the profile seal.

The cutouts can have cambered lateral flanks for bearing against the profile seal. In this manner, a particularly strong wedging of one end of the profile seal is possible.

The corner connectors and the profile seals could be plugged into one another. The connection between corner connector and profile seal could be purely mechanical, such as by means of a plug-and-socket connection.

Between corner connector and profile seal a further, gel-like or very soft connection could be mechanically applied, which further supports the plug-and-socket connection.

The corner connectors and the profile seals could be interconnected by chemical and/or thermal fixing. The connection between corner connector and profile seal can additionally be made by the application of adhesives, by vulcanization or by welding, also by using a hot air gun.

The corner connectors and the profile seals could have bearing surfaces on which an adhesive tape or an adhesive is arranged. The corner connectors and/or the profile seals could be fixed against the cover or the tank by means of adhesive tape, in particular double-sided adhesive tape. For this purpose, the tank and/or the cover can be equipped with a double-sided adhesive tape, which is pulled off prior to assembly. The corner connectors and/or the profile seals could be glued to the surface of the cover or the tank by means of adhesive. This supports the capability of assembly of the components on the one hand, and on the other it ensures additionally that the seal always remains on the desired side if the housing is disassembled.

At least one corner connector could be integrated into a screw or a sleeve. The corner connectors could be vulcanized to a screw or a sleeve and/or could be firmly connected with it, so that the screw and/or the sleeve and the corner connector are integrated into one component. This has the advantage that screws, which are required for the assembly of a housing anyway, can function as corner connectors.

In view of this background, the corner connector could have a cutout, in particular a hole, through which a screw and/or a screw and a sleeve are inserted.

At least one corner connector could have an end stop. The corner connector could have a sleeve and/or a bushing for this purpose, which ensures a constant distance and thus a constant contact pressure on the seal. For this purpose, the sleeves could be firmly connected to the corner connector, in particular by means of gluing or vulcanization.

The corner connectors and/or the profile seals could have electrically conductive particles. The profile seal and/or the profile seal and the corner connectors can be equipped with electrically conductive particles. This will ensure that no interfering electromagnetic radiation can be emitted from and/or enter into a battery housing. Such radiation can occur, for instance, if rapidly changing currents are drawn from the battery. Such radiation can have harmful effects for other susceptible components in the vehicle, in particular the battery monitoring system or the vehicle electronics. The aforementioned particles and/or fibers can consist of carbon black, graphite, carbon nano-tubes, graphenes, or metal, for example.

The corner connectors could be manufactured from a material. Typical processes for this include punching, cutting by means of a saw, laser, or water jet, or other methods of mechanical removal, for example.

The corner connectors could also be manufactured from a profile in sections, where the individual corner connector pieces are then cut off in slices. In this instance, the height of the corner connectors can be adapted to the height of the profile seal and/or the contact pressure of tank and cover.

A housing, in particular a battery housing, could be provided with a seal of the type described here.

The present embodiments can be expanded to additional systems and/or applications, in particular to applications in which an interior space must be permanently protected from an exterior space. In this case, the exterior space can be loaded with gas, or an aqueous or oil-based medium. Depending on the medium and the environmental conditions, particularly the temperature, the seal material must be designed accordingly. The seal can be used in control panels or protective housings, for example, which contain sensitive components or constituents in the interior.

The present embodiments can also be expanded to applications in which an exterior space must be permanently protected against an interior space and/or for which it must be ensured that a medium cannot escape from the interior space. Such applications are conceivable in connection with motors, transmissions, pharmaceutical, chemical or also biochemical or pharmaceutical chemical reactors, tanks, etc. In this connection, the medium in the interior space is either a system component, such as lubrication oil, fuel, cooling liquid, or the like, or a component which is stored or accumulated in the interior.

The abbreviations used in the specification and/or the claims are explained below:

NBR stands for nitrile butadiene rubber. HNBR stands for hydrogenated nitrile butadiene rubber. EPDM stands for ethylene propylene diene rubber. FKM stands for fluoroelastomer, and ACM stands for acrylate rubber.

IP 67 describes the protection class, i.e. protection against water pursuant to DIN EN 60529 and/or DIN 40050 Part 9. Here the protection class comprises:

A) Total protection against electric shock; protection against penetration of dust (dustproof)

B) Protected against water penetration during immersion

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a tank, a seal, and a cover of a battery housing;

FIG. 2 is a horizontal projection of a seal which consists of profile seals and corner connectors;

FIG. 3 is a detailed view of a corner connector with plug-in type profile seals;

FIG. 4 is a sectional view of the cross-section of a profile seal;

FIG. 5 is a sectional view of the cross-section of a profile seal under load;

FIG. 6 is an unsuitable profile seal with a cavity that is open towards the outside;

FIG. 7 is a representation of a leakage flow;

FIG. 8 shows different embodiments of the cutouts in corner connectors;

FIG. 9 shows cutouts in corner connectors with cambered lateral flanks;

FIG. 10 shows further different embodiments of corner connectors; and

FIG. 11 shows further different embodiments of corner connectors, in particular of a corner connector with three cutouts as well as linear connectors.

Corresponding reference numerals indicate corresponding parts throughout the several views of the drawings.

### DETAILED DESCRIPTION

Example embodiments will now be described more fully with reference to the accompanying drawings.

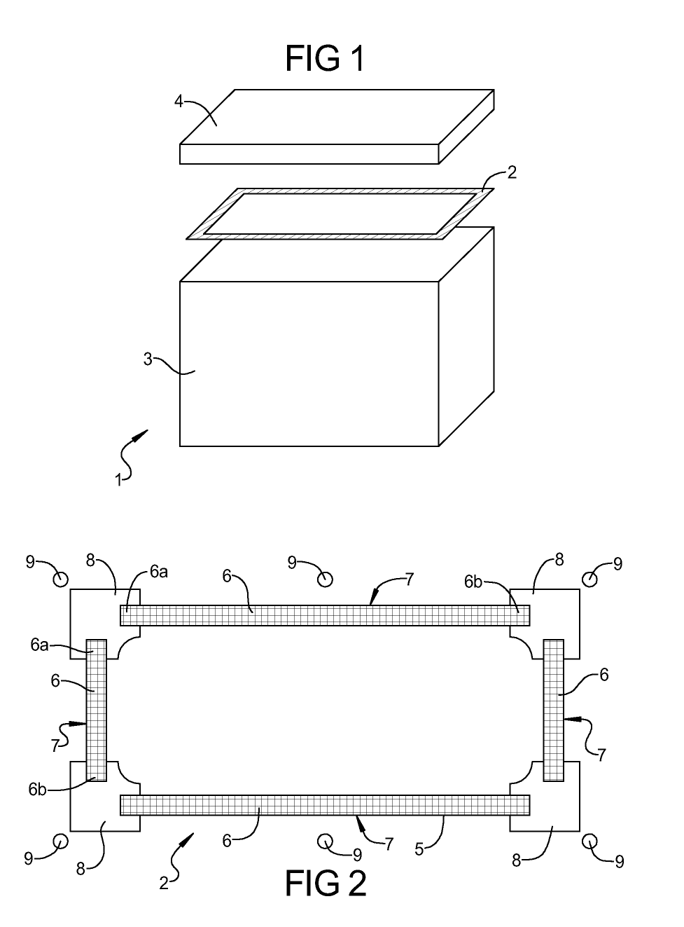

FIG. 1 illustrates a battery housing 1, which has a seal 2. FIG. 1 illustrates a battery housing 1 with three essential components, namely a tank 3, a cover 4, and a seal 2 positioned between these. In principle, welded systems can also be considered. But a design that can be dismantled ensures that in the event of defects inside the battery, such as loose contacts or leakage of the cooling system, the battery housing 1 can be opened and the damage can be repaired. With a welded battery housing 1, even a small defect would result in having to take the entire expensive battery out of operation.

FIG. 2 shows a horizontal projection of the seal 2 for the battery housing 1, comprising a base body 5, the base body 5 having profile seals 6 with profiled sealing surfaces 7, and the profile seals 6 having first ends 6a and second ends 6b, and wherein at least two profile seals 6 are interconnected by a corner connector 8 at one end 6a of each seal.

The corner connectors 8 and the profile seals 6 can be plugged into one another.

FIG. 2 shows that the seal 2 consists of modular arranged profile seals 6 which are placed into corner connectors 8. These surround a tank 3 according to FIG. 1. The profile seals 6 and/or the corner connectors 8 are molded with screws 9, wherein an end stop is ensured using sleeves and/or washers.

The profile seals 6 consist of certain materials. Since water from the outside can be present only occasionally, in addition to the known “water sealing components” such as EPDM, NBR elastomers can also be used. NBR is advantageous, since it has only minor shrinkage following extrusion and can therefore also be cut to size for storage. Elastomers from HNBR, fluoroelastomer, silicone rubber or other elastomer materials can also be used for special applications.

The corner connectors 8 and/or the profile 6 seals can contain electrically conductive particles. In order to shield against electromagnetic radiation, electrically conductive substances, in particular metal or carbon, can be admixed to the elastomers.

These profile seals have a typical hardness ranging from 50-80 shore. For applications in which a housing has to be sealed, outside and/or inside of which oil is present, oil-resistant materials can be used for the profile seals 6. For this purpose, NBR is suitable for moderate conditions. HNBR, ACM or also FKM should be resorted to for increased temperatures.

A negative pressure was applied to the inside of the battery housing 1 illustrated in FIG. 1, and was stored in water. During this experiment, the pressure that had previously built up was recorded, in order to draw conclusions about leakage or leakiness caused by a possible loss of pressure, in addition to a subsequent visual check.

The test procedure is modeled around IP 67 which is described in one standard, in which water applied from the outside at a pressure of 0.1 bar (corresponds to 1 m water head) must not produce a leak in the seal 2 after a period of 30 min.

The seal principle used in the tests performed was a seal 2 that could be arranged in modular form, consisting of corner connectors 8 and profile seals 6. Because of the relatively non-demanding environmental conditions, the profile seals 6 can consist of traditional elastomers such as EPDM or NBR. NBR has the advantage that following cut-off and storage of the profile seal 6, generally no linear contraction is observed. For harsher environments, in particular hot oil, higher-valency elastomers, such as HNBR, ACM or FKM, can be used. Elastomer materials from EPDM or FKM can meet special requirements at low temperatures of less than −30° C., for example. Such requirements are encountered by battery systems, for example, which are used as backup systems for railroads.

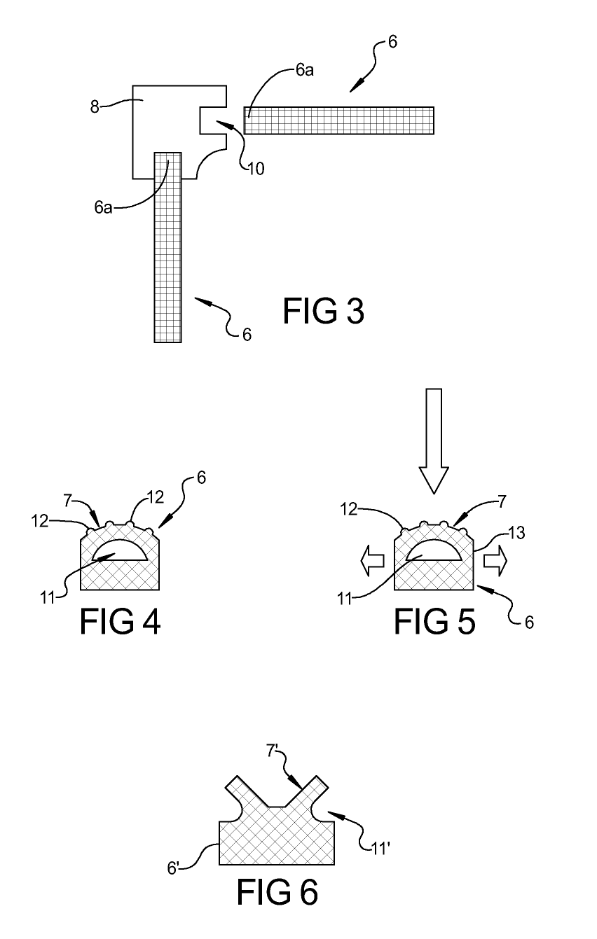

FIG. 3 shows that the corner connectors 8 have cutouts 10 for holding the ends 6a of the profile seals 6. FIG. 3 shows a detailed view of a corner connector 8, into the cutouts 10 of which profile seals 6 are inserted. The material that is used for the corner connector 8 must in any event be softer than that of the profile seal 6. The material can consist of soft solid material, but also of closed-cell foams.

Because the corner connector 8 does not have to compensate tolerances in height, the requirements for its elastic properties are low. The pore sizes with closed-cell foams should be smaller than 0.3 mm, especially for demanding applications, since otherwise liquid can push past at the connecting surface between the foam and the profile seal 6.

FIG. 4 shows that at least one profile seal 6 has an internal cavity 11 that is enclosed by the profile seal material. FIG. 4 shows a profile seal 6 which surrounds a cavity 11. Under application of a load from above, the cross-section must deflect to the outside. The profile seal 6 therefore preferably has an internal cavity 11, which supports this deflection, so that this occurs even at relatively low pressures. An end stop of the cross-section is preferably provided. The presence of longitudinal sealing ribs 12, which act to compensate tolerances, is advantageous. At least one corner connector 8 has an end stop.

FIG. 5 shows that at least one profile seal 6 can be coaxially cambered with the application of pressure to its sealing surface 7. FIG. 5 shows that the profile seal 6 is structured such that with the application of mechanical loading during the assembly of the battery housing 1, such as a distortion, the material yields across the flank faces 13 of the profile seal 6 and therefore deflects to the outside. Here it is important that during this deflection no part of the flank face 13 remains within the unloaded flank line. Therefore, a gap between profile seal 6 and corner connector 8 through the distortion of the tank 3 with the cover 4 is squeezed through the deflection of the profile seal 6, which counteracts leakage. This deflection can be assisted by a cavity 11 inside the profile seal 6. This cavity 11 has the additional benefit that the profile seal 6 achieves a good sealing effect and good tolerance compensation even at comparatively low pressure and/or comparatively low squeezing.

Furthermore, it is also advantageous to arrange ribs 12 on the sealing surface 7 of the profile seal 6, which extend longitudinally on the profile seal 6. These ribs 12 result once again in an improved seal effect.

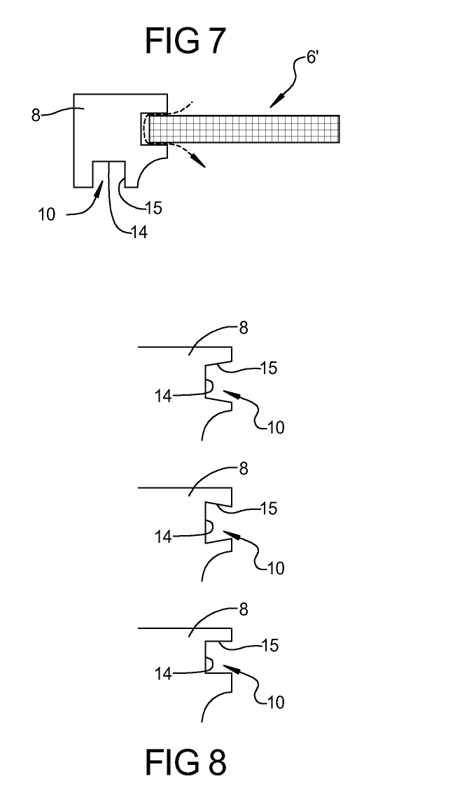

FIG. 6 shows a profile seal 6′ with a concave sealing surface 7′. With a concave flank face bending towards the inside, as is most often the case with profile seals, a lateral cavity 11′, i.e., a cavity that is open on the side, can result, through which water can get into the inside of the battery housing by means of a surprising leakage flow, around the back, as it were. This is shown in FIG. 7. Such profile seals 6′ should therefore be absolutely avoided. For this reason, profile seals 6 without cavities are used for implementing the invention.

FIG. 8 shows corner connectors 8 with different cutouts 10. The corner connectors 8 must be sufficiently soft so that they can follow a flank face 13 that bends towards the outside. The corner connectors 8 must be able to be compacted, as it were. This can be achieved by using elastomers that are clearly softer compared with profile seal 6 or also by using closed-cell elastomer foams.

Open-cell foams permit a leakage flow through the material matrix. But experiments have also shown that closed-cell materials are unsuitable if their pores are too large. Here, excessive roughness is created on the sealing edge of the profile seal to edge connector, through which water and/or liquid can migrate. For applications under conditions which are less critical, such material can be used, however, depending on the circumstances.

The edge connectors used are shown in FIG. 8. All edge connectors 8 have cutouts 10, into which the profile seals 6 can be inserted and/or loaded through a mouth opening. These cutouts are limited by a rear stop flank 14 as well as lateral flanks 15.

Depending on the embodiment, stop flanks 14 and lateral flanks 15 can form a right, an obtuse, or an acute angle. It is also conceivable for the angles between the stop flank 14 and the two lateral flanks 15 to be differently sized.

A cutout 10 which is open to the outside, in which the mouth opening is larger than the stop flank 14 (top illustration of FIG. 8) permits the profile seals 6 to be inserted easily. The cutout 10 has a trapezoidal cross-section. The trapezoidal shape is formed such that the cutout 10 widens in the direction of the profile seal 6.

A cutout 10 which expands to the inside, in which the mouth opening is smaller than the stop flank 14 (center illustration in FIG. 8) results in improved sealing if profile seals 6 are too short or shrink in their length. The trapezoidal shape here is formed such that the cutout 10 tapers in the direction of the profile seal 6.

A rectangular cutout (lower illustration in FIG. 8) is particularly easy to produce.

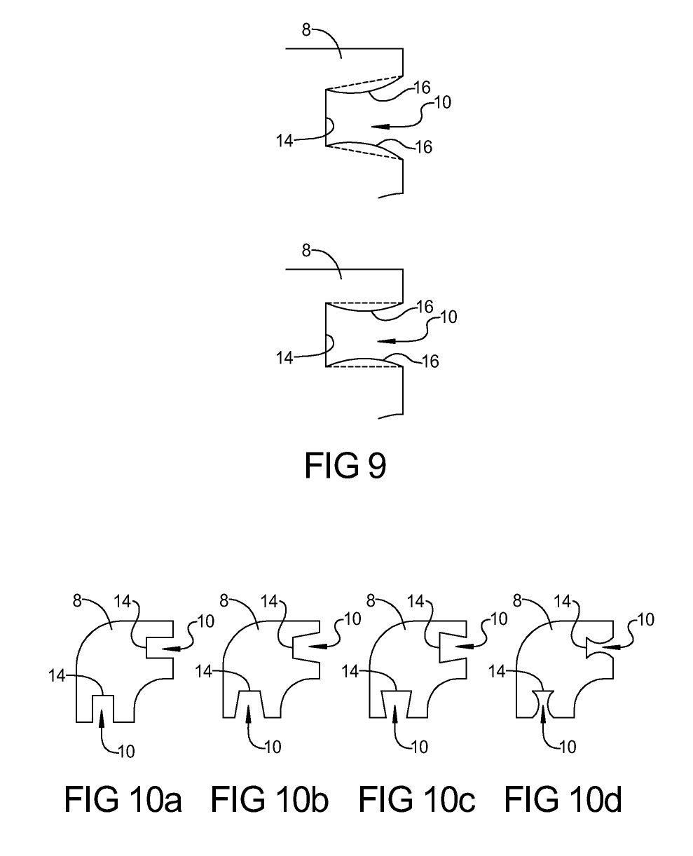

FIG. 9 shows corner connectors 8 in which one or both lateral flanks 16 have cambers which are facing in the direction of the profile seal 6.

Here too, the cutout 10 can be open in a trapezoidal shape to the outside or to the inside and/or can have a fundamentally rectangular form. FIG. 9 shows that the cutouts 10 have cambered lateral flanks 16 for bearing against the profile seal 6.

FIG. 10 shows standard embodiments of corner connectors 8 with rectangular cutout 10 (a), two trapezoidal cutouts 10 with the narrow side as stop flank 14 (b), and/or as mouth opening (c) and an embodiment with cambered lateral flanks 16 (d).

Each of the corner connectors 8 shown here was engineered in three different materials in order to investigate its sealing characteristics. These materials comprise a silicone foam with an average pore diameter larger than 0.3 mm, an EPDM cellular rubber with an average pore size smaller than 0.1 mm and a solid material from EPDM A-KD 30°.

In addition, experiments with an open-cell silicone foam and with the embodiments pursuant to FIG. 10a were performed.

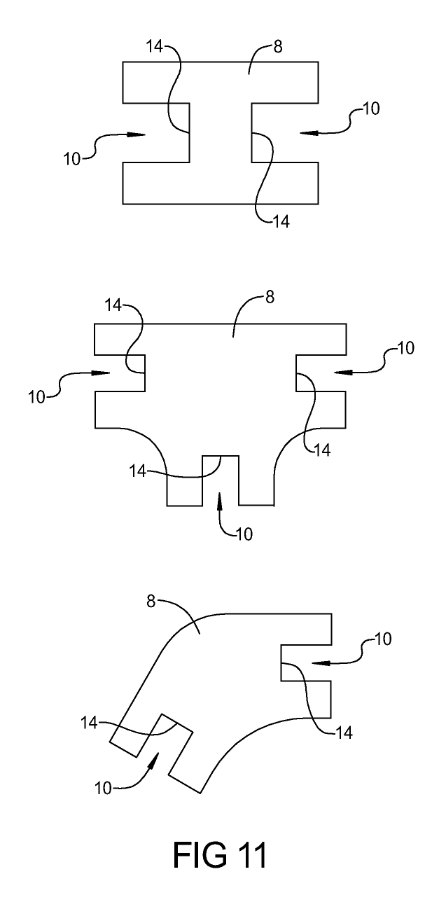

FIG. 11 shows further embodiments of corner connectors 8. The two cutouts 10 can be arranged at an angle of 90° to one another. This is the best embodiment for rectangular housings.

The two cutouts 10 can be arranged at an angle to one another that deviates from 90°. The embodiment shown at the bottom in FIG. 11 can be used for trapezoidal shaped housings or also for partially round housing segments. The two cutouts 10 can also be arranged at an angle of 180° to one another (embodiment top left in FIG. 11). Such components or corner connectors 8 can be used as connection and/or extension elements.

The corner connector 8 can have more than two cutouts 10. This embodiment shown on the right in FIG. 11 can be used with complex housings or for the separation of multiple interior spaces from the environment and from one another.

The sealing components, profile seal 6 or corner connector 8 and/or profile seal 6 and corner connector 8, could be placed into special grooves of a housing. Such a groove results in improved capability of assembly and/or improved fixing. Any steps that occur in this context must be considered when sizing the thicknesses of the sealing components. Alternatively, the sealing components could be applied on an edge. Moreover, by sizing the groove, an end stop and thus a specific compaction of the seal can be ensured.

The following table provides an overview of the experiments performed and their results. In this context, the statements are applicable for all types of geometries of corner connectors 8.

| | | EPDM foam | Silicone foam | |
|---|---|---|---|---|
| | | (closed-cell), | (closed-cell), | |
| | EPDM | average pore | average pore | Silicone foam |
| | solid | size < 0.1 | size > 0.3 | (open-cell), pore |
| | material | mm | mm | size > 0.3 mm |
| Water | + | + | (−) | − |
| Water with | + | + | (−) | − |
| rinsing agent | | | | |
| Water at | + | + | − | − |
| 50° C. | | | | |
| Tolerance, | + | ++ | − | − |
| cover | | | | |
| Tolerance, | +* | ++* | − | − |
| length of | | | | |
| profile seal | | | | |

*Here, compared with the other geometry types, the embodiment pursuant to FIG. 10b (mouth opening widening toward the outside) was found to be somewhat disadvantageous.

The seal 2 must also be leakproof against water to which a cleaning agent has been added. This in fact occurs when a battery housing 1 is placed in the underbody of a vehicle, and the vehicle drives through a car wash.

In this context it is especially critical that the surfactants and/or wetting agents contained in cleaning agents reduce the surface tension of the water and thereby make it much easier for water to penetrate in leakage flows near the surface. For this purpose, the following experiment was conducted:

The “Pril Original” brand detergent (Henkel company) was added to water at a concentration of 0.5 mL/L and the mixture was stirred well.

Using the new medium, the three materials were then tested with the corner connectors 8 pursuant to FIG. 10 a, b, c, and d, according to the previously described experimental setup.

In addition it was investigated whether the system is also leakproof against warm water. For this purpose, the previously mentioned experiments were repeated in a thermostatically controlled heated tank.

In a further experiment, the influence of the tolerance of a warped cover was checked for the sealing effect. For this purpose, sleeves of different lengths were placed into the mounting screws 9.

In a further experiment, the influence that the profile seal length tolerance has on the sealing effect was examined. In this context, the profile seals 6 were deliberately cut too short by 2-3 mm for each cutout.

In addition it was checked whether the system was also leakproof in the event of internal excess pressure.

This can be relevant for batteries, since when opening individual cells in case of damage, gas development occurs as a result of toxic and/or flammable gases with a marked increase in pressure. A seal 2 should also be able to withstand this internal excess pressure. Here, it should be noted, however, that battery housings are usually provided with a pressure release valve and/or a rupture disc, which is intended to discharge this gas development safely to the outside. In other words, significant excess pressures in battery housings for extended periods are irrelevant in practice.

For this purpose, in four experiments, the system of battery housing 1-seal 2 in the water tank, each with EPDM solid material and/or EPDM foam according to the respective embodiment pursuant to FIG. 10, was subjected to an internal excess pressure of 1 bar over a period of 2 hours. During this time, only a slight pressure loss and/or a slight small bubble development occurred on the seal 2.

In a further experiment with stronger compression (sleeve height 4 mm) the seal 2 was able to achieve total sealing with the use of EPDM solid material and/or EP DM foam as material for corner connectors.

In addition, cyclical pressure fluctuations were simulated. Pressure fluctuations occur in battery housings 1, for example, with temperature differences and/or during driving over hills and through valleys, when the battery housing 1 is actually hermetically sealed.

To simulate this, an excess pressure of 1 bar and a negative pressure of 0.1 bar were alternately applied to the system in the water tank in 1 min. cycles. After 2 hours and 120 load changes, the system was initially subjected to a constant negative pressure of 0.1 bar for one hour, and subsequently to a constant excess pressure of 1 bar. In both tests, no pressure changes and/or visible leakage, such as water droplets or air bubbles, occurred.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A seal (2) for a housing, comprising a base body (5), the base body (5) having profile seals (6) with profiled sealing surfaces (7), and the profile seals (6) having first ends (6a) and second ends (6b), characterized in that at least two profile seals (6) are interconnected by a corner connector (8) at one of their ends (6a, 6b) in each case.

2. The seal according to claim 1, characterized in that at least one profile seal (6) can be coaxially cambered with the application of pressure to its sealing surface (7).

3. The seal according to claim 1, characterized in that at least one profile seal (6) has an internal cavity (11) surrounded by the profile seal material.

4. The seal according to claim 1, characterized in that the corner connectors (8) are softer than the profile seals (6).

5. The seal according to claim 1, characterized in that the corner connectors (8) have a multilayer structure.

6. The seal according to claim 1, characterized in that the corner connectors (8) have cutouts (10) for holding the ends (6a, 6b) of the profile seals (6).

7. The seal according to claim 6, characterized in that the cutouts (10) are designed with a trapezoidal cross section.

8. The seal according to claim 7, characterized in that the trapezoidal shape is designed in such a way that the cutout (10) widens in the direction of the profile seal (6).

9. The seal according to claim 7, characterized in that the trapezoidal shape is designed in such a way that the cutout (10) tapers in the direction of the profile seal (6).

10. The seal according to claim 1, characterized in that the cutouts (10) have cambered lateral flanks (16) for bearing against the profile seal (6).

11. The seal according to claim 1, characterized in that the corner connectors (8) and the profile seals (6) can be plugged into one another.

12. The seal according to claim 1, characterized in that the corner connectors (8) and the profile seals (6) can be interconnected by chemical and/or thermal fixing.

13. The seal according to claim 1, characterized in that the corner connectors (8) and the profile seals (6) have bearing surfaces on which an adhesive tape is arranged.

14. The seal according to claim 1, characterized in that at least one corner connector (8) is integrated in a screw or in a sleeve (9).

15. The seal according to claim 1, characterized in that at least one corner connector (8) has an end stop.

16. The seal according to claim 1, characterized in that at least one of the corner connectors (8) and the profile seals (6) have electrically conductive particles.

17. The seal according to claim 1, characterized in that one or more of the corner connectors (8) has/have more than two cutouts for holding the profile seals (6).

18. The seal according to claim 1, characterized in that the corner connectors are made from an elastic, closed cell material.
